(19) United States
(12) Patent Application Publication
(10) Pub. No.: US 2025/0036181 A1
(43) Pub. Date: Jan. 30, 2025

(54) DYNAMIC BATTERY HEALTH MANAGEMENT

(71) Applicant: DELL PRODUCTS L.P., Round Rock, TX (US)

(72) Inventors: Ibrahim Sayyed, Georgetown, TX (US); Adolfo S. Montero, Pflugerville, TX (US); Venkata Rama Krishna Rao Atta, Hyderabad (IN)

(21) Appl. No.: 18/361,855

(22) Filed: Jul. 30, 2023

(51) Int. Cl. G06F 1/30; H01M 10/44

(52) U.S. Cl. CPC G06F 1/305; H01M 10/44

(57) ABSTRACT

An information handling system determines a battery charge level subsequent to power on. If the battery charge level is at a critical battery charge level, the system triggers a battery refresh process, and initiates diagnostics of the battery during the battery refresh process.

### FIELD OF THE DISCLOSURE

The present disclosure generally relates to information handling systems, and more particularly relates to dynamic battery health management.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system determines a battery charge level subsequent to power on. If the battery charge level is at a critical battery charge level, the system triggers a battery refresh process, and initiates diagnostics of the battery during the battery refresh process.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an information handling system configured for dynamic battery health management, according to an embodiment of the present disclosure;

FIG. 3 is a flowchart illustrating a method for dynamic battery health management, according to an embodiment of the present disclosure;

FIG. 4 is a flowchart illustrating of a method for dynamic battery health management, according to an embodiment of the present disclosure;

FIG. 5 is a flowchart illustrating of a method for dynamic battery health management, according to an embodiment of the present disclosure; and

FIG. 6 is a flowchart illustrating of a method for dynamic battery health management, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

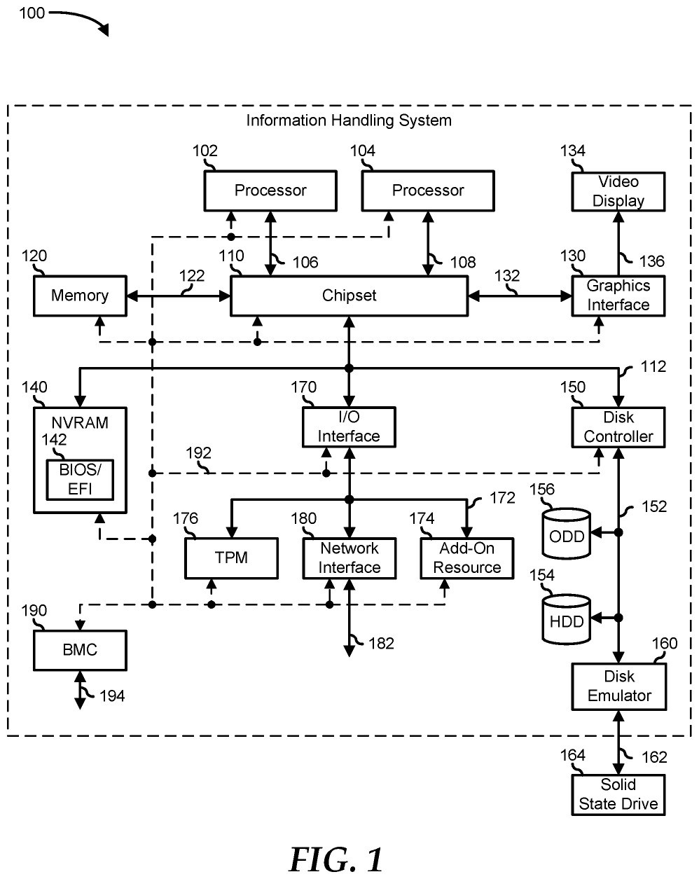

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller. A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a RedfishR interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Portable information handling systems, such as laptop and notebook computers, may include portable power sources like batteries. The batteries may be located inside the portable information handling system and allow it to operate away from a power outlet. Users can experience situations where their portable information handling system is left unused for weeks or months. This typically ends up draining the battery, which may also affect battery health. For example, the chemistry of lithium batteries is generally adversely affected when the battery is stored fully discharged for a long time. To address this and other concerns, the present disclosure provides a system and method for dynamic battery health management to increase battery service life.

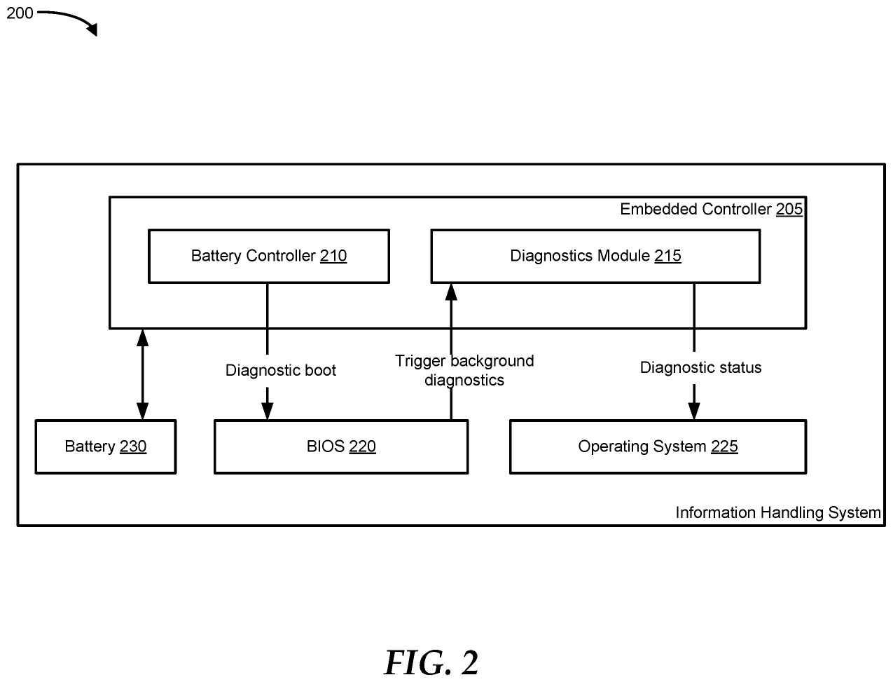

FIG. 2 shows an information handling system 200 configured for dynamic battery health management. Information handling system 200, which is similar to information handling system 100 of FIG. 1, includes an embedded controller 205, a BIOS 220, an operating system 225, and a battery 230. Embedded controller 205, which is similar to BMC 190 of FIG. 1, includes a diagnostics module 215 and a battery controller 210. Embedded controller 205 is communicatively coupled to BIOS 220, operating system 225, and battery 230. The components of information handling system 200 may be implemented in hardware, software, firmware, or any combination thereof. The components shown are not drawn to scale and information handling system 200 may include additional or fewer components.

In addition, connections between components may be omitted for descriptive clarity. In various embodiments, information handling system 200 may not include each of the components shown in FIG. 2. Additionally, or alternatively, information handling system 200 may include various additional components in addition to those that are shown in FIG. 2. Furthermore, some components that are represented as separate components in FIG. 2 may in certain embodiments instead are integrated with other components. For example, in certain embodiments, all or a portion of the functionality provided by the illustrated components may instead be provided by components integrated into one or more processor(s) as a system-on-a-chip.

Embedded controller 205 may be configured to determine whether information handling system 200 has been left unused without power for an extended period. To accomplish this, embedded controller 205 may log a real-time clock timestamp and battery charge level, also referred to as charge level, when information handling system 200 is in the process of shutting down. Embedded controller 205 may also check and log the real-time clock timestamp when the information handling system is subsequently powered up. Based on the two timestamps, embedded controller 205 may determine the length of time that information handling system 200 was without power or unused.

Embedded controller 205 may also check the battery charge level during the power-up. If the battery charge level was near depletion for a long period, embedded controller 205 may perform a battery charge/discharge cycle to refresh the battery chemistry and evaluate the health status of battery 230. A battery charge depletion threshold and a storage time threshold may be pre-determined. For example, embedded controller 205 may determine whether the battery charge level is at or below a battery charge depletion threshold, which may be set and/or updated based on a policy or by an administrator. In one embodiment, the battery charge depletion threshold maybe ten percent. In addition, the policy or the administrator may also set and/or update the storage time threshold for the length of time that the battery may be without power or left unused. In one embodiment, the storage time threshold may be set to one month. Embedded controller 205 may further log information ascertained above to help a service center specialist determine whether a battery failure is due to the user's fault in failing to charge battery 230 before the long-term storage of information handling system 200.

Thus, embedded controller 205 may detect whether battery 230 is in an over-discharged condition based on its current available charge and the total time that information handling system 200 was in storage, also referred to herein as platform storage time. Platform storage time is a delta between the timestamp of the last shutdown and the timestamp at power-up. Embedded controller 205, or in particular battery controller 210, may boot information handling system 200 in diagnostics and update mode when it detects that battery 230 is in a critical condition. Embedded controller 205 may also boot information handling system 200 when the battery charge level is low and the platform storage time is above the storage time threshold. The battery charge level may be low when it is at or below a minimum battery charge level which could be set to 10% as an example. At this point, embedded controller 205 may log data associated with the battery charge level and the platform storage time. In particular, embedded controller 205 may create a data log, such as a BIOS_IQ record of the aforementioned information.

BIOS 220 may be configured to notify the user of the boot mode, such as whether to boot in diagnostics and update mode, update mode, or normal mode. BIOS 220 may also be configured to provide the user with an option to boot into a diagnostics and update mode to assess a complete system health state before booting information handling system 200. The option may be displayed to the user via a textual or graphical user interface on a display screen. Upon confirmation of the option to perform diagnostics, BIOS 220 may then trigger background diagnostics in embedded controller 205 or diagnostics module 215 in particular, wherein it may perform a set of tests on battery 230. BIOS 220 may also notify the user that the background diagnostic tests are running. Embedded controller 205 may continuously update the user on the ongoing status of the background diagnostic tests. After completion of the diagnostic tests, embedded controller 205 or diagnostics module 215 in particular, may transmit a diagnostic status to operating system 225. In addition, BIOS 220 may provide the user with an option to perform a BIOS update before booting to operating system 225.

If the user opted to perform a BIOS update, then the BIOS may check for available update(s), such as a firmware or a BIOS update, once battery 230 reaches the maximum battery charge level. The BIOS may apply the update(s) before booting to operating system 225. The updates may be downloaded over advanced configuration and power interface, hypertext transfer protocol (HTTP), HTTP secure, or similar.

BIOS 220 may also trigger a battery chemistry refresh by enabling a battery charge/discharge cycle. For example, BIOS 220 may transmit a command to embedded controller 205 to perform the battery chemistry refresh for at least one or two battery charge cycles. For example, embedded controller 205 may charge battery 230 until it reaches a maximum battery charge level of 85% and then discharge battery 230 until it reaches a minimum battery charge level of 20% for at least one battery charge/discharge cycle. The battery charge/discharge policy may set how many battery charge/discharge cycles may be implemented to refresh the battery chemistry. The user may also be educated on how to avoid damaging battery 230 or prolong battery life when storing the information handling system for an extended period. Embedded controller 205 may perform the diagnostics and the update process during the battery chemistry refresh process.

Those of ordinary skill in the art will appreciate that the configuration, hardware, and/or software components of information handling system 200 depicted in FIG. 2 may vary. For example, the illustrative components within information handling system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

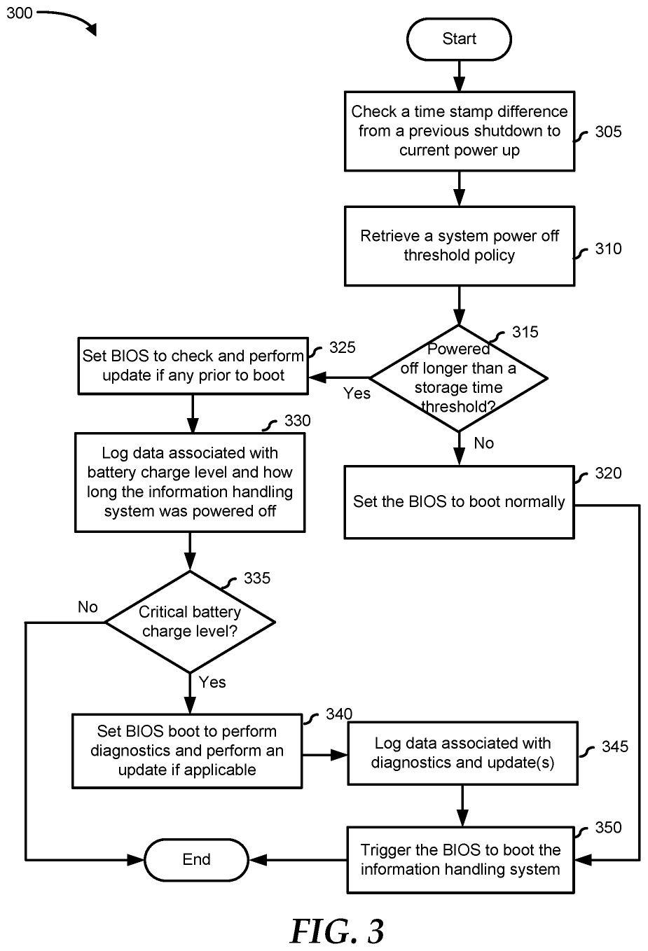

FIG. 3 illustrates a method 300 for dynamic battery health management. Method 300 may evaluate the length of time the information handling system was powered off and whether this length of time meets a storage time threshold. The method may then prepare the information handling system to instrument a battery charge/discharge cycle, diagnostics, and BIOS and/or firmware update. For example, BIOS may initialize a process to record diagnostics or update information. Method 300 may be performed by one or more components of information handling system 200 of FIG. 2. In particular, method 300 may be performed by embedded controller 205 of FIG. 2. However, while embodiments of the present disclosure are described in terms of information handling system 200 of FIG. 2, it should be recognized that other systems may be utilized to perform the described method. One of skill in the art will appreciate that this flowchart explains a typical example, which can be extended to advanced applications or services in practice.

Method 300 typically starts at block 305 where an embedded controller may check a timestamp difference between a previous shutdown and the current power-up of an information handling system. The method may proceed to block 310, where the method may retrieve a system power-off threshold policy. The system power-off threshold policy may include rules associated with determining a BIOS boot mode, battery chemistry refresh threshold, etc. For example, the system power threshold policy may include the storage time threshold, minimum battery charge level, maximum charge level, number of battery charge/discharge cycles, etc. The system power threshold policy may also determine whether to perform diagnostics, battery chemistry refresh, update(s), etc.

At decision block 315, the embedded controller may determine whether the information handling system was powered off for longer than the storage time threshold. If the information handling system was powered off longer than the storage time threshold, then the “YES” branch is taken and the method proceeds to block 325. If the information handling system was not powered off longer than the storage time threshold, then the “NO” branch is taken and the method proceeds to block 320. At block 320, the embedded controller may set the BIOS to boot the information handling system normally. For example, the embedded controller may set the value of BIOS boot mode to normal mode. The method may proceed to block 350.

At block 325, the embedded controller may set the BIOS to check for and apply available updates prior to boot. For example, the embedded controller may set the value of BIOS boot mode to update mode. When the BIOS boot mode is set to update, then the BIOS may check for downloadable updates and perform the update of the information handling system prior to boot. The update may be applied to the BIOS, the operating system, firmware, software, a driver, etc. of the information handling system. The method proceeds to block 330 where the embedded controller may log information associated with the timestamp difference from the previous shutdown to the current power-up. The embedded controller may also log whether the information handling system has been powered off longer than the storage time threshold. For example, the embedded controller may log BIOS-IQ platform data.

The method may proceed to decision block 335 where the embedded controller may determine whether the battery is at a critical battery charge level. The critical battery charge level may be defined in the system power-off threshold policy. In addition, the administrator may also set or update the critical battery charge level, such as at ten percent. If the battery charge level is at or below the critical battery charge level, then the “YES” branch is taken and the method may proceed to block 340. If the battery charge level is not at the critical battery charge level, then the “NO” branch is taken and the method ends.

At block 340, the embedded controller may set the BIOS to perform diagnostics and check and apply an update if applicable prior to boot. For example, the embedded controller may set the BIOS boot mode to diagnostics and update mode. In another example, a value of the battery diagnostic flag may be set to “ON” which may trigger the embedded controller to execute the battery charge/discharge cycle process. Accordingly, if the battery diagnostic flag has a value of “OFF”, then the embedded controller may not execute the battery charge/discharge cycle process. The method may proceed to block 345 where the embedded controller may log additional information. For example, the embedded controller may log the results of the diagnostics and the applied update if any. In particular, the embedded controller may create a BIOS-IQ platform record. The method may proceed to block 350 where the embedded controller may trigger the BIOS to boot the information handling system. For example, the embedded controller may send a signal to the BIOS to initiate the boot process.

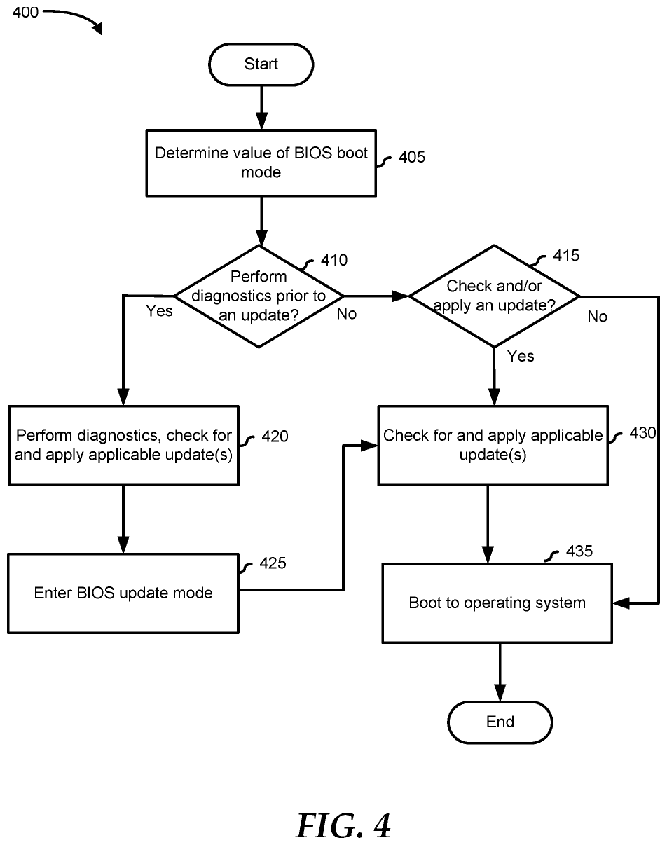

FIG. 4 illustrates a method 400 for battery health management. In particular, method 400 may be performed when an embedded controller triggers the BIOS to boot the information handling system, such as in block 350 of FIG. 3. Method 400 may be performed by one or more components of information handling system 200 of FIG. 2. In particular, method 400 may be performed by embedded controller 205 and BIOS 220 of FIG. 2. However, while embodiments of the present disclosure are described in terms of information handling system 200 of FIG. 2, it should be recognized that other systems may be utilized to perform the described method. One of skill in the art will appreciate that this flowchart explains a typical example, which can be extended to advanced applications or services in practice.

Method 400 typically starts at block 405 where the BIOS determines boot mode by querying the embedded controller. BIOS may query the embedded controller for the value of BIOS boot mode during a pre-EFI initialization state of a boot process via mailbox. The BIOS may prepare to boot the information handling system based on the value of the SBIOS boot mode.

The method may proceed to decision block 410 wherein the BIOS may determine whether to perform diagnostics prior to checking and/or applying for updates before boot. The determination may be based on the value of the BIOS mode setting. If the BIOS is to perform the diagnostics prior to checking and/or applying the updates, then the “YES” branch is taken and the method proceeds to block 420. If the BIOS is not to perform the diagnostics prior to checking and/or applying the updates, then the “NO” branch is taken and the method proceeds to decision block 415.

At decision block 415, the BIOS may determine whether it should check and/or apply an update before booting. The determination may be based on the value of the BIOS mode setting. If the BIOS determines that it should check and/or apply an update before boot, then the “YES” branch is taken and the method proceeds to block 430. If the BIOS determines that it should not check and/or apply an update before boot, then the “NO” branch is taken and the method proceeds to block 435.

At block 420, the BIOS and/or the embedded controller may perform diagnostics of the information handling system. The method may proceed to block 425, where the BIOS enters the BIOS update mode and proceeds to block 430. At block 430, the BIOS may check for and apply the applicable update(s). After applying the update(s), the method proceeds to block 435 where the BIOS boots to the operating system. After which the method ends.

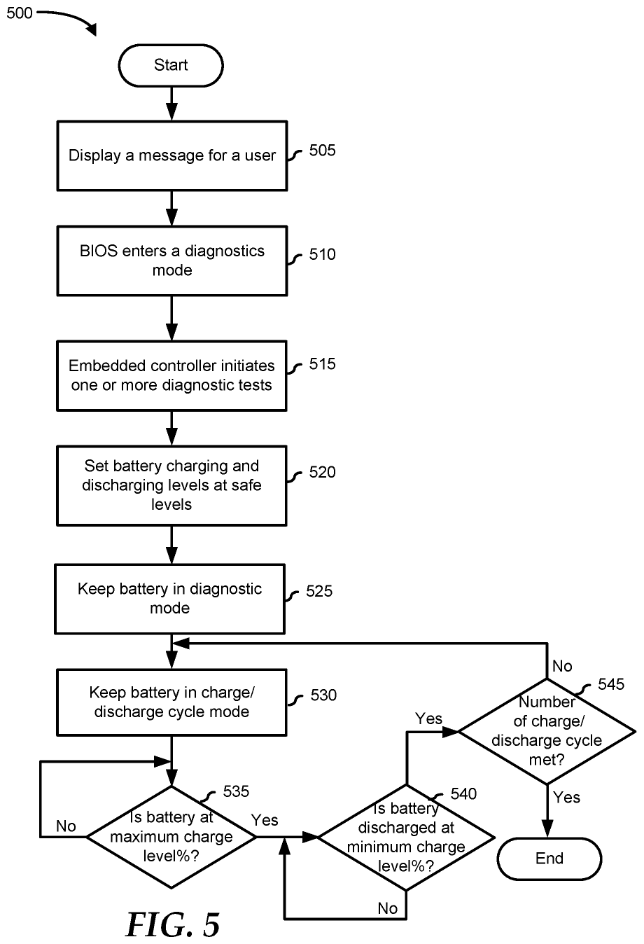

FIG. 5 shows a flowchart of a method 500 which is block 420 of FIG. 4 in greater detail. Method 500 typically starts at block 505 where the BIOS displays a message to a user of the information handling system. The message may include information associated with the data that was logged at method 300 of FIG. 3. The method proceeds to block 510 wherein BIOS enters a diagnostics mode. At block 515, the embedded controller may initiate one or more diagnostic tests. For example, the embedded controller may initiate one or more battery diagnostic tests. The battery diagnostic tests may be initiated or performed during the battery chemistry refresh.

The embedded controller may also initiate a security scan of the information handling system. In addition, the embedded controller may create a health assessment report based on the result of the diagnostic tests. For example, the health assessment report may generate a report on the health of the battery and/or on the security scan of the information handling system. At block 520, the embedded controller may set battery charging and discharging levels at safe levels, which include a minimum charge threshold and a maximum charge threshold. For example, the minimum charge level may be set at 25% while the maximum charge level may be set at 85%.

At block 525, the embedded controller may keep the battery in the battery diagnostics mode. In addition, the embedded controller may log information associated with the results of the battery tests. At block 530, the method may keep the battery in charge/discharge cycle mode. A number of battery charge/discharge cycles may have been set based on the system power-off threshold policy and/or the administrator. For example, an administrator may set the battery charge/discharge cycle to one or two cycles. A minimum of one battery charge/discharge cycle may be set as default.

The method proceeds to decision block 535, where the embedded controller determines whether the battery is at the maximum charge level. If the battery is at the maximum charge level, then the “YES” branch is taken, and the method proceeds to decision block 540. If the battery is not at the maximum charge level, then the “NO” branch is taken and the method loops back to decision block 535. At decision block 540, the embedded controller determines whether the battery is at the minimum charge level. If the battery is at the minimum charge level, then the “YES” branch is taken, and the method proceeds to decision block 545. If the battery is not at the minimum charge level, then the “NO” branch is taken and the method loops back to decision block 540. In this example, the battery may be charged up to 85% and then discharged down to 25%.

At decision block 545, the embedded controller determines whether the number of battery charge/discharge cycles is met. The number of battery charge/discharge cycles may have been set at block 530. If the number of battery charge/discharge cycles is met, then the “YES” branch is taken and the method ends. If the number of battery charge/discharge cycles is not met, then the “NO” branch is taken, and the method proceeds to block 530.

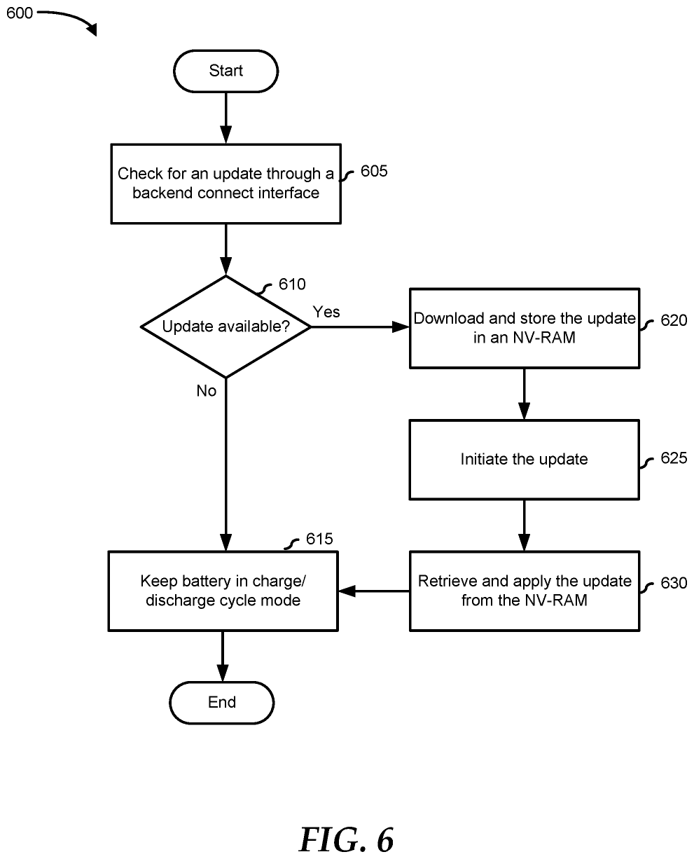

FIG. 6 shows a flowchart of a method 600 which is block 430 of FIG. 4 in greater detail. Method 600 typically starts at block 605 where the BIOS checks for an update through a backend connect interface to a backend server via a wired or wireless network. One example of a backend connect interface is BIOSConnect™ via the firmware update over the air (FOTA) application by Dell®. The method proceeds to decision block 610 where is determined if there are any available updates. If there are available updates, then the “YES” branch is taken and the method proceeds to block 620. If there are no available updates, then the “NO” branch is taken and the method proceeds to block 615.

At block 620, the BIOS may download and store the update image in an NV-RAM. The method may proceed to block 625 where the embedded controller may initiate the update, such as a BIOS or firmware update. For example, the method may flash the BIOS. The method proceeds to block 630 where the BIOS may retrieve the update from the NV-RAM and apply the update. The method proceeds to block 615, where the embedded controller may keep the battery in charge/discharge cycle mode. Afterwards, the method ends.

Although FIG. 3 through FIG. 6 show example blocks of method 300, method 400, method 500, and method 600 in some implementations, the aforementioned methods may include additional blocks, fewer blocks, different blocks, or differently arranged blocks than those depicted in FIG. 3 through FIG. 6. Those skilled in the art will understand that the principles presented herein may be implemented in any suitably arranged processing system. Additionally, or alternatively, two or more of the blocks of method 300 through method 600 may be performed in parallel. For example, block 325 of method 300 and block 425 of method 400 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
evaluating an information handling system, by a processor, to determine whether the information handling system was powered off longer than a pre-determined period;
if the information handling system was powered off longer than the pre-determined period, then determining whether a battery of the information handling system is at a critical battery charge level; and
if the battery is at the critical battery charge level, then performing a battery chemistry refresh.

2. The method of claim 1, wherein the pre-determined period is based on a policy.

3. The method of claim 1, wherein the evaluating of the information handling system includes comparing a first timestamp when the information handling system was shut down and a second timestamp when the information handling system was powered on.

4. The method of claim 1, wherein the battery chemistry refresh includes a battery charge/discharge cycle.

5. The method of claim 4, wherein during the battery charge/discharge cycle, the battery is charged until a battery charge level reaches a maximum battery charge threshold.

6. The method of claim 5, wherein during the battery charge/discharge cycle, subsequent to the battery reaching the maximum battery charge threshold, discharging the battery until the battery charge level reaches a minimum battery charge threshold.

7. The method of claim 1, further comprising determining a battery charge level when the information handling system is powered on.

8. The method of claim 1, further comprising creating a log of data generated during the evaluating of the information handling system.

9. The method of claim 1, further comprising setting a basic input/output system flag to trigger execution of a battery charge/discharge process.

10. An information handling system, comprising:
a processor; and
a memory storing code that when executed causes the processor to perform operations, the operations including:
determining a battery charge level subsequent to power on of the information handling system;
if the battery charge level is at a critical battery charge level, then triggering a battery refresh process; and
initiating diagnostics of the battery during the battery refresh process.

11. The information handling system of claim 10, wherein the operations further comprise checking for an available update.

12. The information handling system of claim 10, wherein the operations further comprise if there is an available update, then applying the available update.

13. The information handling system of claim 10, wherein the operations further comprise performing a security scan.

14. The information handling system of claim 10, wherein the operations further comprise querying a boot mode during a pre-extensible firmware interface initialization phase of a boot process.

15. The information handling system of claim 10, wherein the battery is charged to a maximum battery charge level and discharged to a minimum battery charge level during the battery refresh process.

16. A non-transitory computer-readable medium to store instructions that are executable to perform operations comprising:
evaluating an information handling system to determine whether the information handling system was powered off longer than a pre-determined period;
if the information handling system was powered off longer than the pre-determined period, then determining whether a battery of the information handling system is at a critical battery charge level; and
if the battery is at the critical battery charge level, then performing a battery chemistry refresh.

17. The non-transitory computer-readable medium of claim 16, wherein the pre-determined period is based on a policy.

18. The non-transitory computer-readable medium of claim 16, wherein the evaluating of the information handling system includes comparing a first timestamp when the information handling system was shut down and a second timestamp when the information handling system was powered on.

19. The non-transitory computer-readable medium of claim 16, wherein the battery chemistry refresh includes a battery charge/discharge cycle.

20. The non-transitory computer-readable medium of claim 16, wherein the operations further comprise determining a battery charge level when the information handling system is powered on.
